(19) United States
(12) Patent Application Publication
(10) Pub. No.: US 2013/0151873 A1
(43) Pub. Date: Jun. 13, 2013

(54) IMAGE PROCESSING APPARATUS, CONTROL METHOD THEREFOR, AND COMPUTER-READABLE STORAGE MEDIUM

(71) Applicant: CANON KABUSHIKI KAISHA, Tokyo (JP)

(72) Inventor: Hidenori Higashi, Kawasaki-shi (JP)

(73) Assignee: CANON KABUSHIKI KAISHA, Tokyo (JP)

(21) Appl. No.: 13/685,495

(22) Filed: Nov. 26, 2012

(30) Foreign Application Priority Data
Dec. 9, 2011 (JP) 2011-270615

(51) Int. Cl. G06F 1/26

(52) U.S. Cl. CPC G06F 1/26
USPC 713/300

(57) ABSTRACT

When an image processing apparatus according to this invention accepts a shutdown instruction, and completes execution of shutdown processing, and switches the operation state of the power source switch to an OFF state using a driving unit of the power source switch if the shutdown instruction is accepted via an external device communicably connected to the image processing apparatus.

### BACKGROUND OF THE INVENTION

1. Field of the Invention

The present invention relates to an image processing apparatus, a control method therefor, and a computer-readable storage medium.

2. Description of the Related Art

In recent years, an image processing apparatus has a function of connecting itself to a network as a standard function. An image processing apparatus that can be connected to a network receives and processes data and commands from an information processing apparatus such as a personal computer via a network, thereby executing various types of data processing.

In a large number of offices, image processing apparatuses that can be connected to networks are connected to personal computers or other image processing apparatuses via networks, and exchange data with them. In such an office, ideally, the administrator is able to disconnect the power source of the image processing apparatus by a remote operation, instead of disconnecting the power source of the image processing apparatus as he or she moves to the front of the image processing apparatus. Japanese Patent Laid-Open No. 8-6679, for example, proposes a technique of adding an expansion card to an information processing apparatus, and operating the expansion card using a power source different from that used for the main body, thereby implementing power-on and power-off by a remote operation.

Unfortunately, the above-mentioned related art technique poses the following problem. In, for example, Japanese Patent Laid-Open No. 8-6679, it is necessary to add an expansion card to an information processing apparatus, and operate a CPU and memory on the expansion card using a power source different from that used for the main body. Therefore, in Japanese Patent Laid-Open No. 8-6679, to allow power-on by a remote operation, it is necessary to supply power to the expansion card to receive an ON command even when the information processing apparatus is OFF. As another example, an image processing apparatus which, in power-off, displays a message such as “Please turn off the power source switch” on a user interface after the end of shutdown processing to prompt the user to turn off the power source switch is available. When such an image processing apparatus is to be powered off by a remote operation, the user is not expected to be present near the image processing apparatus. This means that the power source switch is not expected to be turned off even if a given message is displayed on the user interface. Hence, in such a state, the operation state of the power source switch may be kept ON despite a change in driving state of the image processing apparatus to a shutdown, resulting in a continuous waste of power.

A more serious problem is posed when energy application from a power supply facility is stopped for, for example, a security check while the power source switch of the image processing apparatus is ON and power source cable is pulled in, and is started again after the end of the security check. In such a case, because image processing apparatuses are started up at once, their power consumption peaks coincide with each other, thus imposing too much load on the power supply facility.

### SUMMARY OF THE INVENTION

The present invention enables realization of an image processing apparatus, a control method therefor, and a computer-readable storage medium which prevent inconsistency between the driving state of the apparatus and the operation state of a power source switch by operating the power source switch without requiring any direct user operation.

One aspect of the present invention provides an image processing apparatus comprising: an acceptance unit configured to accept a shutdown instruction from the image processing apparatus; a shutdown unit configured to execute shutdown processing of the image processing apparatus in accordance with the accepted shutdown instruction; and a control unit configured to, when the execution of the shutdown processing by the shutdown unit is completed, switches an operation state of the power source switch to an OFF state using a driving unit of the power source switch if the shutdown instruction is accepted via an external device communicably connected to the image processing apparatus.

Another aspect of the present invention provides a control method for an image processing apparatus, the method comprising: causing an acceptance unit to accept a shutdown instruction from the image processing apparatus; causing a shutdown unit to execute shutdown processing of the image processing apparatus in accordance with the accepted shutdown instruction; and causing a control unit to, when the execution of the shutdown processing in the causing the shutdown unit to execute the shutdown processing of the image processing apparatus is completed, switch an operation state of the power source switch to an OFF state using a driving unit of the power source switch if the shutdown instruction is accepted via an external device communicably connected to the image processing apparatus.

Still another aspect of the present invention provides a computer-readable storage medium storing a computer program for causing a computer to execute each step in a control method for an image processing apparatus.

Further features of the present invention will become apparent from the following description of exemplary embodiments with reference to the attached drawings.

### BRIEF DESCRIPTION OF THE DRAWINGS

FIG. 1 is a block diagram illustrating an example of the configuration of an image processing apparatus according to the first embodiment;

FIG. 2 is a block diagram illustrating an example of the configuration of a controller in the image processing apparatus according to the first embodiment;

FIG. 3 is a view showing display of an operation unit in a shutdown as a Comparative Example;

FIG. 4 is a view illustrating an example of the arrangement of a solenoid power source switch provided in the image processing apparatus according to the first embodiment;

FIG. 5 is a flowchart showing a processing procedure according to the first embodiment; and

FIG. 6 is a flowchart showing a processing procedure according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Configuration of Image Processing Apparatus

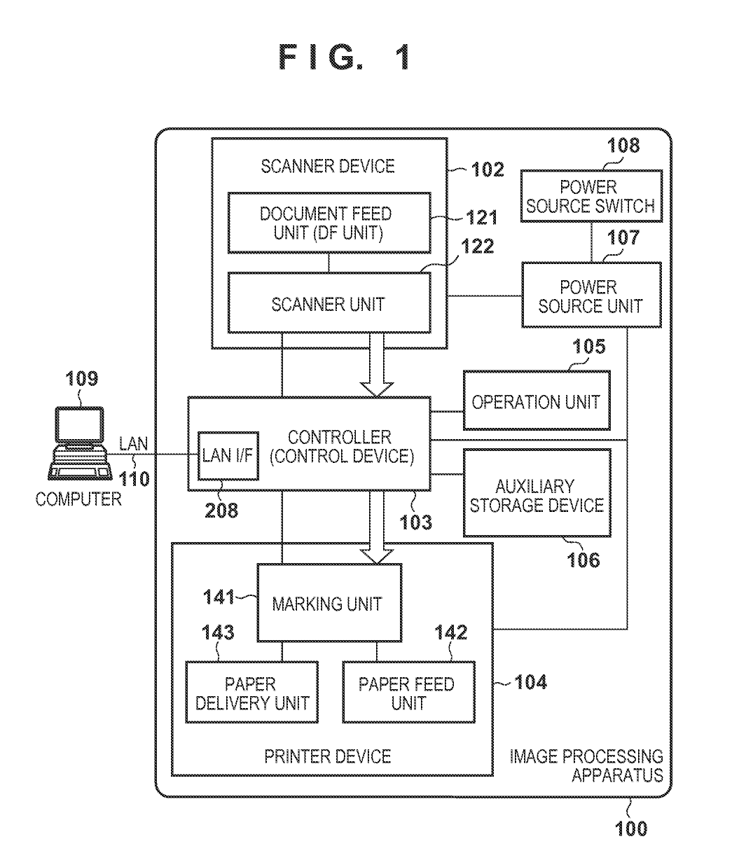

The first embodiment of the present invention will be described below with reference to FIGS. 1 to 5. An image processing apparatus will be taken as an embodiment of an information processing apparatus according to the present invention. An example of the configuration of the image processing apparatus in this embodiment will be described first with reference to FIG. 1.

An image processing apparatus 100 includes a scanner device 102, printer device 104, operation unit 105, auxiliary storage device 106, power source unit 107, power source switch 108, and controller 103. The scanner device 102 optically reads an image from a document, and converts it into a digital image. The printer device 104 outputs the digital image onto a paper medium. The operation unit 105 serves as a user interface for operating the image processing apparatus 100, and has a touch panel liquid crystal display. The auxiliary storage device 106 stores, for example, a digital image and a control program. The power source unit 107 controls power supply to the image processing apparatus 100. The controller 103 is connected to each module, and issues an instruction to this module, thereby executing a job on the image processing apparatus 100. The image processing apparatus 100 can also execute, for example, digital image input/output, job issuance, and device instructions from a computer 109 via a LAN 110. The LAN 110 and controller 103 are connected to each other via a LAN I/F 208.

The scanner device 102 includes a document feed unit 121 capable of automatically, sequentially replacing bundles of documents, and a scanner unit 122 capable of optically scanning a document and converting it into a digital image, and transmits the converted image data to the controller 103. The printer device 104 includes a marking unit 141 for printing image data on fed paper, a paper feed unit 142 capable of sequentially feeding paper sheets from a paper bundle one by one, and a paper delivery unit 143 for delivering the printed paper sheets.

<Configuration of Controller>

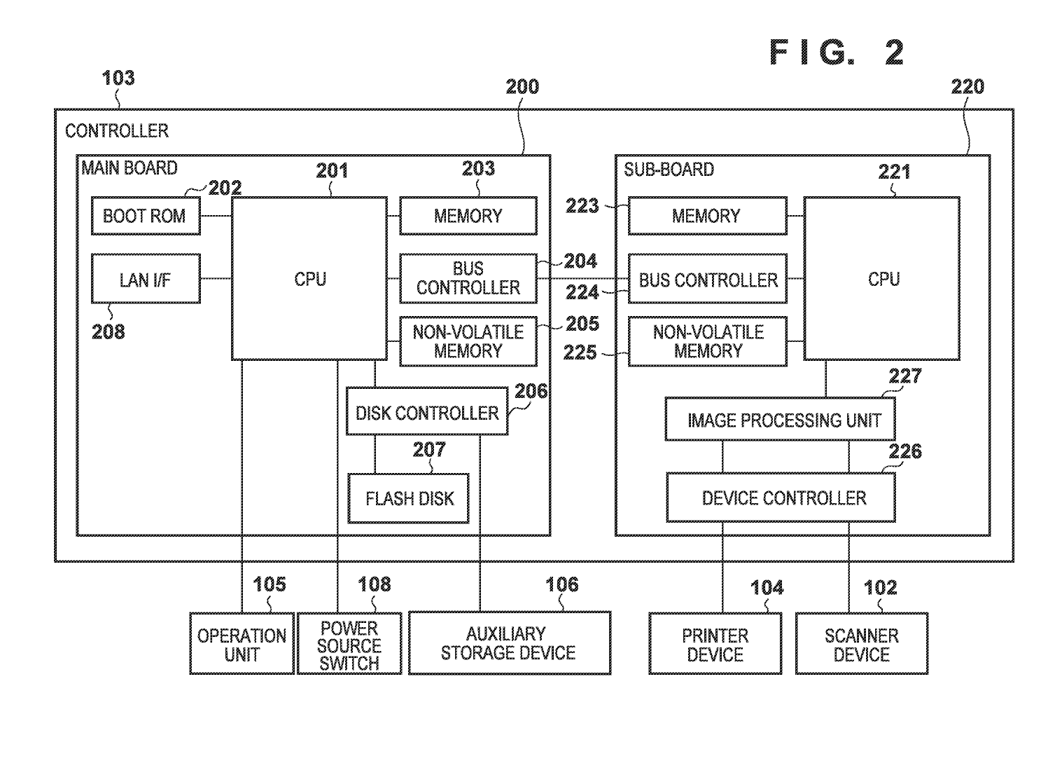

An example of the configuration of the controller 103 in the image processing apparatus 100 will be described next with reference to FIG. 2. The controller 103 includes a main board 200 and sub-board 220.

The main board 200 serves as a so-called general-purpose CPU system, and includes a CPU 201, a boot ROM 202, a memory 203, a bus controller 204, a non-volatile memory 205, a disk controller 206, a flash disk 207, and the LAN I/F 208. The CPU 201 systematically controls the overall board. The boot ROM 202 includes a boot program. The memory 203 is used as a work area by the CPU 201. The bus controller 204 functions as a bridge to an external bus. The non-volatile memory 205 retains data even after the power source is disconnected. The disk controller 206 controls storage devices. The flash disk (for example, an SSD) 207 serves as a storage device which is implemented by a semiconductor device and has a relatively low capacity. The LAN I/F 208 is an interface for connecting the apparatus to an external device via a network. Referring to, for example, FIG. 1, the computer (external device) 109 is communicably connected to the image processing apparatus 100 via the LAN I/F 208. The main board 200 is connected to, for example, the operation unit 105 and auxiliary storage device 106 as external devices.

The sub-board 220 is implemented by a relatively small general-purpose CPU system and image processing hardware, and includes a CPU 221, memory 223, bus controller 224, non-volatile memory 225, image processing unit 227, and device controller 226. The CPU 221 systematically controls the overall board. The memory 223 is used as a work area by the CPU 221. The bus controller 224 functions as a bridge to an external bus. The non-volatile memory 225 retains data even after the power source is disconnected. The image processing unit 227 executes real-time image processing. The device controller 226 is connected to the scanner device 102 and printer device 104, and controls data exchange with these devices.

Note that FIG. 2 is a schematic block diagram. For example, although the CPUs 201 and 221 include large numbers of sets of CPU peripheral hardware including chip sets, bus bridges, and clock generators in practice, an illustration thereof is simplified in FIG. 2, and the present invention is not limited to this block configuration.

The operation of the controller 103 will be described herein by taking a copy of an image on a paper medium as an example. When the user issues an image copy instruction from the operation unit 105, the CPU 201 sends a document image read command to the scanner device 102 via the CPU 221. The scanner device 102 optically scans a paper document, converts it into digital image data, and inputs it to the image processing unit 227 via the device controller 226. The image processing unit 227 performs DMA transfer of the digital image data to the memory 223 via the CPU 221 to temporarily store it in the memory 223.

When the CPU 201 confirms that the digital image data is stored in the memory 223 in a predetermined amount or as a whole, it issues an image output instruction to the printer device 104 via the CPU 221. The CPU 221 notifies the image processing unit 227 of the location (address) of the image data stored in the memory 223. The digital image data in the memory 223 is transmitted to the printer device 104 via the image processing unit 227 and device controller 226 in accordance with a synchronization signal from the printer device 104, and printed on a paper medium by the printer device 104. When a plurality of copies of the image data in the memory 223 are to be printed, the CPU 201 stores this image data in the auxiliary storage device 106. Therefore, in printing the second and subsequent copies of the image data, the CPU 221 can send an image to the printer device 104 without receiving it from the scanner device 102.

### Comparative Example

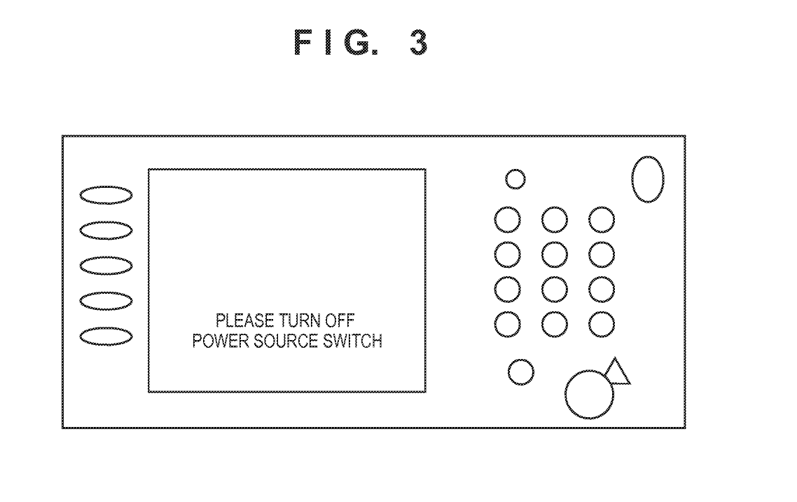

An example of display on the operation unit in a shutdown as a Comparative Example of the present invention will be described next with reference to FIG. 3. When the user executes a shutdown operation via the operation unit, the CPU of the main board starts the shutdown processing of the image processing apparatus in response to a shutdown command. More specifically, the CPU executes the various types of shutdown processing of, for example, the scanner device, printer device, and sub-board. A message such as “Please turn off the power source switch” is displayed on the display unit of the operation unit at the end of the various types of shutdown processing to prompt the user to turn off the power source switch. In this manner, when the image processing apparatus in the Comparative Example accepts a shutdown instruction, it issues various shutdown instructions to finally prompt the user to turn off the power source switch. With this operation, the driving state of the image processing apparatus (a shutdown state in this case) is matched with the operation state of the power source switch (an OFF state in this case).

However, because it is not guaranteed that the user is present near the image processing apparatus, the power source switch is not always expected to be turned off even if a given message is displayed on the user interface. Especially when a shutdown instruction is issued by a remote operation, the user is less likely to be present near the image processing apparatus. Hence, in such a state, the driving state of the image processing apparatus may not coincide with the operation state of the power source switch, resulting in a continuous waste of power. A characteristic configuration of the present invention in order to solve such a problem will be described below.

<Arrangement of Power Source Switch>

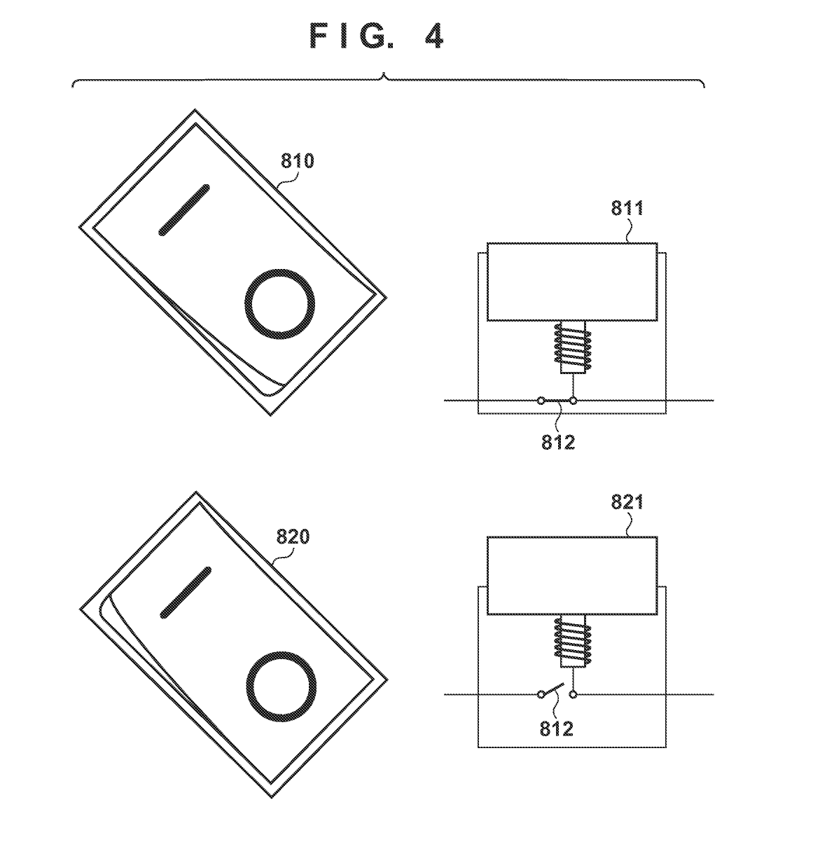

An example of the arrangement of the solenoid power source switch 108 provided in the image processing apparatus 100 of this embodiment will be described next with reference to FIG. 4. Reference numerals 810 and 820 denote the ON/OFF states of the power source switch 108 shown in FIG. 1. More specifically, reference numeral 810 denotes an ON state; and 820, an OFF state.

In the ON state 810, a switch 812 is enabled and energy is applied to the solenoid, as shown in a state 811. On the other hand, when the switch 812 is disabled, no power is applied to the solenoid, so the operation state of the power source switch 108 changes to the OFF state 820. In a state 821, the solenoid is supplied with no drive current and pulled, so the operation state of the power source switch 108 changes to the OFF state 820. In this manner, the operation state of the power source switch 108 can be switched to the ON state 810 or the OFF state 820 by enabling or disabling the switch 812 using the solenoid. That is, the adoption of the power source switch 108 according to this embodiment allows the user to turn on or off the power source switch 108 without requiring any direct user operation.

<Processing Sequence>

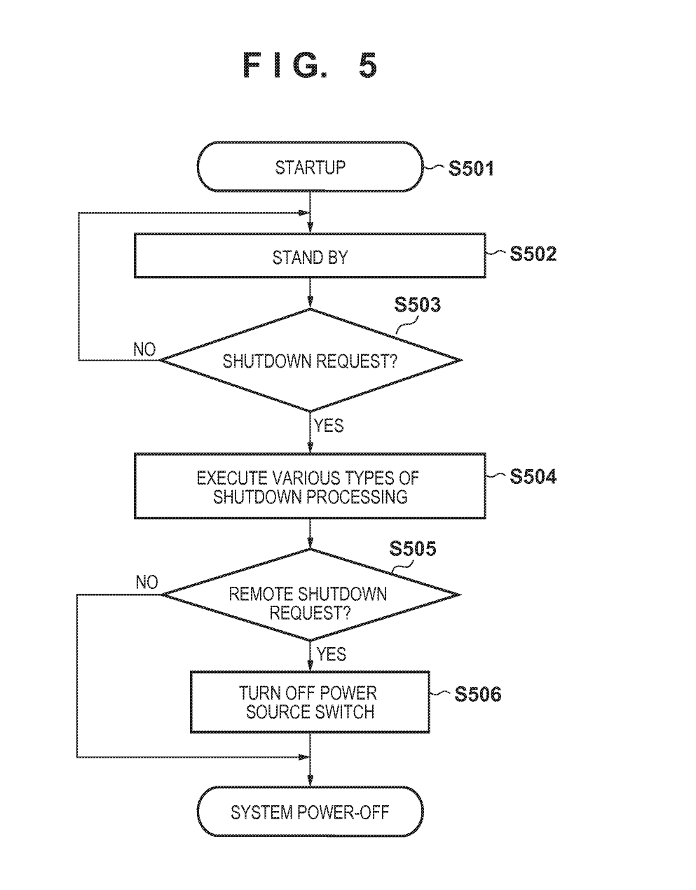

The processing sequence of the image processing apparatus 100 in this embodiment will be described next with reference to FIG. 5. The following processing is implemented when the CPU 201 reads out a control program stored in, for example, the non-volatile memory 205 or auxiliary storage device 106 or flash disk 207 into the memory 203, and executes it.

When the image processing apparatus 100 is started up in step S501, the CPU 201 changes the driving state of the image processing apparatus 100 to a standby state in which it can accept various requests such as a print request in step S502. In step S503, the CPU 201 determines whether the request accepted by the image processing apparatus 100 is a shutdown request. If the request accepted by the image processing apparatus 100 is not a shutdown request, the process returns again to step S502, in which the CPU 201 changes the driving state of the image processing apparatus 100 to a standby state in which it stands by to accept various requests.

On the other hand, if the request accepted by the image processing apparatus 100 is a shutdown request, the process advances to step S504, in which the CPU 201 executes various types of shutdown processing. After the various types of shutdown processing are completed, the process advances to step S505, in which the CPU 201 determines whether the shutdown request is a remote shutdown request. If the shutdown request is not a remote shutdown request (If the shutdown request is accepted by the user's turning off the power source switch 108), the system is powered off.

On the other hand, if the shutdown request is a remote shutdown request, the process advances to step S506, in which the CPU 201 controls the switch 812 to the state 821 shown in FIG. 4 to pull the solenoid, thereby turning off the power source switch 108. Then, the system is powered off. The operation state of the power source switch 108 shown in FIG. 4 changes from the ON state 810 to the OFF state 820 upon turn-off.

As described above, the image processing apparatus according to this embodiment, if the shutdown request issued to the image processing apparatus is a remote shutdown request, the image processing apparatus operates the switch 812 shown in FIG. 4 to the state 821 to turn off the power source switch 108. In this manner, according to the present invention, when the image processing apparatus 100 is to be shut down by a remote operation, the power source switch 108 can be turned off even if the user is absent near the image processing apparatus 100. This makes it possible to prevent the occurrence of inconsistency between the driving state of the image processing apparatus 100 and the ON/OFF state of the power source switch 108, and, in turn, to prevent various failures due to the occurrence of the inconsistency.

### Second Embodiment

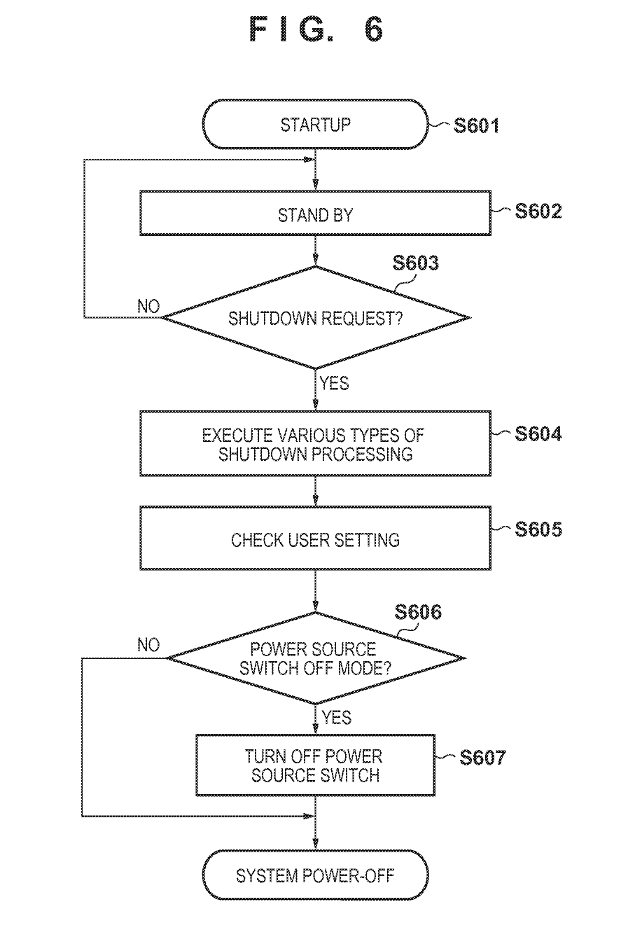

The second embodiment of the present invention will be described below with reference to FIG. 6. In the first embodiment, it is determined whether the image processing apparatus 100 is to operate the power source switch, based on whether the shutdown instruction issued to the image processing apparatus 100 is a remote shutdown instruction. However, in the second embodiment, it is determined whether the image processing apparatus 100 is to operate the power source switch, based on the following user setting. The user setting in this embodiment means the setting of a power source switch OFF mode to control a power source switch 108 to an OFF state in accordance with input by the user (operator) via an operation unit 105. Therefore, in this embodiment, the operation unit 105 is an example of a setting unit.

The processing sequence of an image processing apparatus 100 in this embodiment will be described with reference to FIG. 6. The following processing is implemented when a CPU 201 reads out a control program stored in, for example, a non-volatile memory 205 or auxiliary storage device 106 or flash disk 207 into a memory 203, and executes it.

When the image processing apparatus 100 is started up in step S601, the CPU 201 changes the driving state of the image processing apparatus 100 to a standby state in which it can accept various requests such as a print request in step S602. In step S603, the CPU 201 determines whether the request accepted by the image processing apparatus 100 is a shutdown request. If the request accepted by the image processing apparatus 100 is not a shutdown request, the process returns again to step S602, in which the CPU 201 changes the driving state of the image processing apparatus 100 to a standby state in which it stands by to accept various requests.

On the other hand, if the request accepted by the image processing apparatus 100 is a shutdown request, the process advances to step S604, in which the CPU 201 executes various types of shutdown processing. After the various types of shutdown processing are completed, the process advances to step S605, in which the CPU 201 checks the user setting. In step S606, the CPU 201 determines whether the power source switch OFF mode is set as the checked user setting. If the power source switch OFF mode is set, the process advances to step S607.

If the power source switch OFF mode is set as the user setting, in step S607 the CPU 201 disables a switch 812, as shown in a state 821 of FIG. 4, to pull the solenoid, thereby turning off the power source switch 108. Upon the process in step S607, the operation state of the power source switch 108 changes from an ON state 810 to an OFF state 820.

On the other hand, if the power source switch OFF mode is not set as the user setting, regardless of whether the shutdown request is a remote shutdown request, the system is powered off.

As described above, the image processing apparatus according to this embodiment, if the power source switch OFF mode is set, the image processing apparatus operates the switch 811 shown in FIG. 4 to the state 821 to turn off the power source switch 108.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-270615 filed on Dec. 9, 2011, which is hereby incorporated by reference herein in its entirety.

What is claimed is:

1. An image processing apparatus comprising:
an acceptance unit configured to accept a shutdown instruction from the image processing apparatus;
a shutdown unit configured to execute shutdown processing of the image processing apparatus in accordance with the accepted shutdown instruction; and
a control unit configured to, when the execution of the shutdown processing by said shutdown unit is completed, switches an operation state of the power source switch to an OFF state using a driving unit of the power source switch if the shutdown instruction is accepted via an external device communicably connected to the image processing apparatus.

2. The apparatus according to claim 1, further comprising:
a setting unit configured to set a power source switch OFF mode to control the power source switch to the OFF state in accordance with input by the operator; and
a determination unit configured to determine whether or not the power source switch OFF mode is set by said setting unit,
wherein said control unit switches the operation state of the power source switch to the OFF state using the driving unit of the power source switch if said determination unit determines that the power source switch OFF mode is set.

3. The apparatus according to claim 1, wherein
the driving unit includes a solenoid, and
said control unit switches the operation state of the power source switch by controlling a power supply to the solenoid.

4. The apparatus according to claim 1, wherein
the control unit configured not to switches an operation state of the power source switch to an OFF state using a driving unit of the power source switch if the shutdown instruction is not accepted via an external device communicably connected to the image processing apparatus.

5. The apparatus according to claim 1, wherein
the control unit configured not to switches an operation state of the power source switch to an OFF state using a driving unit of the power source switch if the shutdown instruction is accepted by the user's turning off the power source switch.

6. A control method for an image processing apparatus, the method comprising:
causing an acceptance unit to accept a shutdown instruction from the image processing apparatus;
causing a shutdown unit to execute shutdown processing of the image processing apparatus in accordance with the accepted shutdown instruction; and
causing a control unit to, when the execution of the shutdown processing in the causing the shutdown unit to execute the shutdown processing of the image processing apparatus is completed, switch an operation state of the power source switch to an OFF state using a driving unit of the power source switch if the shutdown instruction is accepted via an external device communicably connected to the image processing apparatus.

7. A computer-readable storage medium storing a computer program for causing a computer to execute each step in a control method for an image processing apparatus, defined in claim 6.
